(19) United States
(12) Patent Application Publication
(10) Pub. No.: US 2014/0111616 A1
(43) Pub. Date: Apr. 24, 2014

(54) Structured light 3D scanner with refractive non-absorbing pattern forming element

(71) Applicant: Ilya Blayvas, Holon (IL)

(72) Inventor: Ilya Blayvas, Holon (IL)

(21) Appl. No.: 13/656,720

(22) Filed: Oct. 21, 2012

(51) Int. Cl. F21V 9/00; H04N 13/02

(52) U.S. Cl. CPC F21V 9/00; H04N 13/02
USPC 348/46; 362/231

(57) ABSTRACT

A structured light 3D scanner consisting of a pattern projector; a digital imaging camera; and a controlling and processing circuitry is disclosed. Several novel variants of pattern projector are claimed. One embodiment comprises one or more transparent refractive pattern forming element, and two or more independently switchable light sources. Another embodiment comprises an array of light emitting diodes (LEDs), grown on the same semiconductor substrate, and an optical lens projecting the image formed by the said diode array.

Sequential acquisition of video frames with synchronous switching between the light sources in the pattern projector produces a sequence of images obtained under different illumination patterns. Processing these images produces a sequence of 3D scans of the scene.

### CROSS REFERENCE TO RELATED APPLICATIONS

| | | | |
|---|---|---|---|
| 11/750,029 | November 2008 | Blayvas | 356/603 |
| 7,224,384 | May 2007 | Iddan et al. | 348/207.99 |
| 7,057,654 | June 2006 | Roddy et al. | 348/277; 348/279 |
| 6,788,210 | September 2004 | Huang et al. | 340/612; 382/154; |
| | | | 382/286 |
| 6,781,676 | August 2004 | Wallace et al. | 356/4.03; 250/221; |
| | | | 250/559.29; |
| 6,885,464 | April 2005 | Pfeiffer et al. | 356/602; 356/603; |
| | | | 433/29 |
| 6,057,909 | May 2000 | Yahav et al. | 356/5.04; |
| | | | 313/103CM; |
| | | | 313/105CM; |
| 5,965,875 | October 1999 | Merrill | 250/226; 250/208.1; |
| | | | 250/214.1; |
| 4,802,759 | February 1989 | Matsumoto et al. | 356/603; 356/3.03; |
| | | | 702/167 |
| 4,687,326 | August 1987 | Corby Jr. | 356/5.01; 2, 5.04, |
| | | | 141.4, 141.5, |
| 4,611,292 | September 1986 | Ninomiya et al. | 702/153; 152 |
| | | | 348/94; 382/153; |

### STATEMENT REGARDING FEDERALLY SPONSORED RESEARCH OR DEVELOPMENT

Not Applicable.

### REFERENCE TO SEQUENCE LISTING

Nor Applicable.

### BACKGROUND OF THE INVENTION

This invention belongs to the field of structured light 3D scanners. 3D scanners acquire a three dimensional shape of the object and are used in multiple applications, such as: Gaming industry, where 3D scan of the gamer body and face are used to take a feedback or to immerse his avatar into the virtual reality; Medical applications, such as 3D scanning of the dental area; automatic car driving; and numerous other established and emerging applications.

Conventional image is a projection of a three dimensional scene onto a two dimensional image plane, and therefore the depth information is lost. In order to produce a 3D map of the scene numerous methods and apparatus had been proposed, including the time-of flight techniques, 3D stereo, and structured light pattern projection techniques.

The time of flight techniques measure a 3D map by measuring the time of flight of auxiliary light towards the object and back to the camera. For example, in U.S. Pat. No. 7,224,384 the ultra-short light pulse is sent towards the object. This ultra-short light pulse resembles the wall of light moving in space, and hence it is sometimes called a ‘wall of light’. After reflection from an object, the reflected wall of light obtains the shape of the object. An ultra-fast optical gate transmits the leading part of the reflected pulse, and cuts off the trailing part. Thus measuring the amount of light that passed through the shutter allows to reconstruct the 3D shape of the object.

The time of flight approach suffers from several limitations. Providing high energy concentration into the ultra-short pulses, using ultra-fast light gates, and accurate measurements of the flight time are physically challenging tasks, requiring expensive and bulky electronics, increasing the size, energy consumption and price of the systems, and decreasing the achieved accuracy.

In 3D from stereo techniques the 3D map is obtained by processing two images obtained from the stereo-pair of the cameras. This approach is inspired by stereo vision of humans and animals—when the 3D information is obtained by processing information from two eyes. The distance to a point is obtained by triangulation of the rays from two cameras. 3D from stereo technique relies upon finding the pairs of corresponding points on two images—for each pixel of the first camera one must determine the matching pixel of the second camera. Unfortunately in many cases, especially for the smooth feature-less surfaces, it is impossible to reliably find the corresponding points, which limits the robustness of 3D from stereo method.

A structured light 3D scanner comprises a pattern projector and a camera. A pattern projector projects one or more specially designed patterns onto the object. The patterns are designed to allow determining the corresponding projector ray from the images acquired by camera. Knowing both the ray from the camera and the ray from the projector allows reconstructing the point of their intersection in 3D space.

Having a compact, lightweight and inexpensive pattern projector is crucial for structured light 3D scanner. In Ser. No. 11/750,029 Blayvas teaches one way to construct such a pattern projector. He suggests using switchable light sources and partially transparent light mask to create the switchable patterns. This allows a compact, light-weight and low-cost pattern projector. However the pattern projector described in Ser. No. 11/750,029 uses a light absorbing semi-transparent mask. This light absorbing mask wastes energy, decreasing the battery life, illumination level, increasing the required power, heat dissipation, increasing the size and price of the light sources.

In this disclosure we disclose novel pattern projectors, that have significant advantages over prior art, including power and light energy saving via use of refractive pattern-casting elements instead of light absorbing masks. This allows increasing the illumination level, improving range and accuracy of the 3D scanner, decreasing the size and price of the light sources, decreasing the required power and heat dissipation and increasing the battery life. Furthermore, the disclosed pattern projectors can have additional important functionality: the projector can be operated in the mode of uniform patterns projection, to be used as a camera flash or auxiliary illumination lamp.

Finally, a rapid progress in light emitting semiconductors brought into existence new bright, efficient and highly luminous light emitting diodes and laser diodes, including the vertically emitting LEDs and vertical cavity laser diodes. We disclose how to employ and further enhance these technologies in order to produce an efficient pattern projector, which can also be used as a generic video projector.

### BRIEF SUMMARY OF THE INVENTION

The present invention is a structured light 3D scanner, comprising a specially designed pattern projector with two or more switchable light sources and a transparent refractive non-absorbing pattern forming element; an imaging camera sequentially acquiring image frames in synchronization with switching of the light sources in the projector; and a special hardware and or software processing the acquired images to obtain corresponding 3D scans.

The first embodiment of pattern projector has two or more switchable light sources positioned behind a refractive element in such a way that after passing through a refractive element, the light from each light source forms a specially designed pattern. In one embodiment there are three independently switchable light sources, and a refractive element of sine-modulated thickness. The lights sources and refractive pattern forming element are designed and positioned to cast the sine modulated patterns on the scene. The three sine-modulated patterns, formed by the three light sources are mutually phase shifted by 2 Pi/3.

The refractive pattern forming element can be a transparent plate with of varying thickness or Fresnel lens or phase-shifting diffraction pattern.

The second embodiment of pattern projector uses an array of light emitting diodes or laser diodes grown on the same substrate with the optical lens forming and casting a pattern onto the scene.

The controlling circuit switches between the light sources synchronously with frames acquisition in the camera. The processing circuit processes the acquired image frames, extracting the single 3D scan from every 3 consecutive image frames. The 3D scans can be uses as a single stand-alone 3D scan, performed at particular moment, or as a continuous 3D video flow, when the scans are evaluated sequentially at a video rate.

The present invention has multiple advantages over state of the art scanners. One embodiment of present invention has similar architecture to that described in Ser. No. 11/750,029, which is incorporated here by reference, and therefore heritages the same advantages over the prior art: compact size and weight, low power consumption, low cost, high accuracy etc.

Furthermore, Ser. No. 11/750,029 teaches us a method and apparatus of a pattern projector using a light-absorbing mask, with sine-modulated transparency. The present invention however demonstrates how same, similar or different illumination patterns can be formed by using specially designed fully transparent refractive element. The light-absorbing pattern mask of Ser. No. 11/750,029 absorbs and wastes at least 50% of the light energy, while the present invention fully utilizes 100% of the light energy, forming the light pattern by redirecting the light in the proper directions, this means that the present invention allows to save 50% of battery energy, 50% of power and price of the light sources maintaining the same light power, decrease heat dissipation and/or increase the efficient range, and accuracy of 3D scanner.

One of the potentially biggest markets of the 3D scanners are smart-phones and hand-held devices, where decreasing the power consumption is crucial. Since the pattern generation of the structured light 3D scanner can often be the dominant power consumer, the invention allowing 100% increase in the power efficiency is of crucial importance.

Additionally, the superposition of three phase-shifted sine-modulated patterns yields a flat illumination, which allows to build specialized control circuitry, switching all the light sources simultaneously to use the pattern projector as a camera flash, auxiliary illumination source for camera, or as an illumination lamp. This dual use is particularly appealing in the hand-held device integration, where cameras usually have an illuminating flash, and/or illuminating lamp.

The second embodiment of pattern projector, based on array of LEDs and optical projecting lens can be further used as a generic video projector.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. In the drawings, like reference numerals designate corresponding parts throughout the several views.

FIG. 1 schematically shows one embodiment of structured light 3D scanner, comprising a fixed pattern projector and an imaging camera.

FIG. 2 schematically shows the fixed pattern projector in accordance with one embodiment of present invention.

FIG. 3 Illustrates the formation of the different light stripes by different light sources, as their light passes through a single refractive stripe, shaped as a one-dimensional cylindrical lens.

FIG. 4 Illustrates the formation of the sine-like patterns by refractive element, composed as several adjacent refractive stripes.

FIG. 5 shows a schematic diagram of the procedure of calculation of the shape of refractive element and geometry of pattern projector.

FIG. 6 schematically shows a pattern forming element in the form of Fresnel lens or diffraction pattern, where the element profile is reduced by step-like shifts of appropriate parts of the refractive element.

FIG. 7 schematically shows a pattern projector consisting of array of light emitting diodes or laser diodes grown on the same semiconductor substrate, and using the optical lens to form a projected pattern.

FIG. 8 shows a schematic block diagram of 3D scanner according to one embodiment of the present invention.

FIG. 9 shows a schematic diagram of operation of the 3D Scanner Controller.

FIG. 10 shows a schematic diagram of an algorithm for 3D scan calculation.

FIG. 11 shows a non-limiting example of time sequences of Illumination patterns, acquired images and calculated 3D scans according to one embodiment of present invention.

FIG. 12 shows a non-limiting example of integration of disclosed 3D scanning apparatus in the smartphone.

### DETAILED DESCRIPTION OF THE PREFERRED EMBODIMENT

Many aspects of the present disclosure can be better understood with reference to the following drawings. The components in the drawings are not necessarily to scale, emphasis instead being placed upon clearly illustrating the principles of the present disclosure. In the drawings, like reference numerals designate corresponding parts throughout the several views.

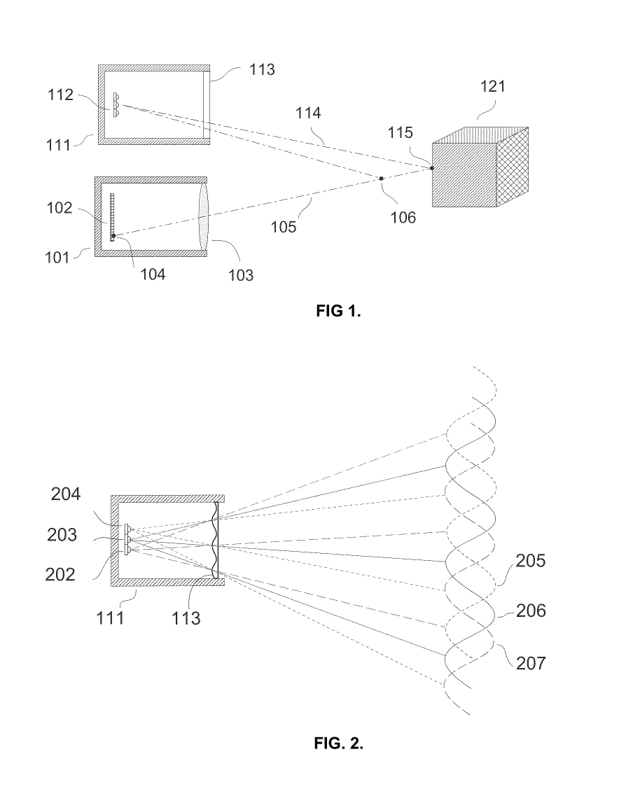

FIG. 1 illustrates the operation principles of structured light 3D scanner. It schematically shows an imaging camera 101, pattern projector 111 and an object 121. A pixel 104 of a camera image sensor 102 images the object point 115. However, the depth information is lost in the camera, and the same pixel 104 can correspond to any point along the ray 105, for example to a point 106. The pattern projector allows solving this ambiguity, by providing auxiliary illumination in the forms of specially designed patterns. From one or more images acquired under patterned illumination from pattern projector 111, with the information encoded into pixel 104, and possibly its vicinity reconstructing an exact ray 114 from pattern projector. Knowing both rays 105 and 114 allows determining the location of point 115 in 3D space, which lies on intersection of these rays. 112 are the light sources of the pattern projector, and 113 is a refractive pattern-forming element. Switching between the light sources 112 results in different projected patterns formed by pattern forming element 113.

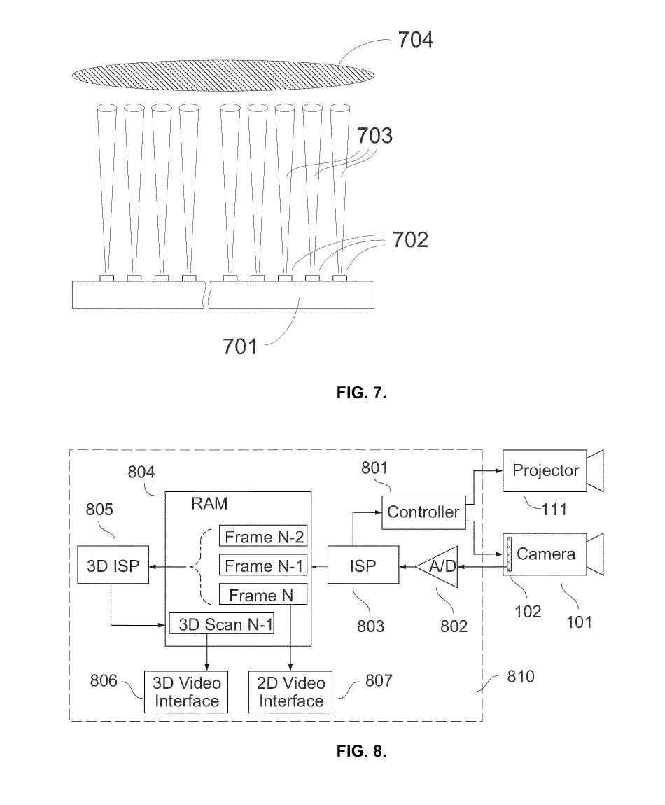

FIGS. 2-4 illustrate one embodiment of pattern projector, based on several switchable light sources and pattern forming element. FIG. 7 illustrates another embodiment of pattern projector, based on the array of light emitting diodes (LEDs) grown on the same semiconductor substrate and assembled together with optical lens, projecting the image formed by the said array of LEDs.

FIG. 2 illustrates the formation of different light patterns by different light sources in the pattern projector 111. The light from the light source 202 after passing through refractive pattern-forming element 113 forms a pattern 205. The light from the light source 203 after passing through refractive pattern-forming element 113 forms a pattern 206. The light from the light source 204 after passing through refractive pattern-forming element 113 forms a pattern 207. In one embodiment of present invention the mutually phase-shifted sine-like patterns are used, however specific shape and relative position of generated patterns may vary, as should be obvious to anybody skilled in the art.

The basic principles of pattern formation will be explained below, for specific non-limiting example. For illustration of this invention we present the sine-like mutually phase-shifted patterns, however it should be clear that the ideas and guiding principles disclosed here will allow to anybody skilled in the art to design a pattern forming element for multiple other projected patterns, suitable for 3D reconstruction. These patterns can be various forms of grids, meshes, oscillating functions, etc. These patterns can be very different from the examples of the patterns presented in this disclosure; however the generation and use according to the principles and ideas claimed in the current invention should be obvious to anybody skilled in the art.

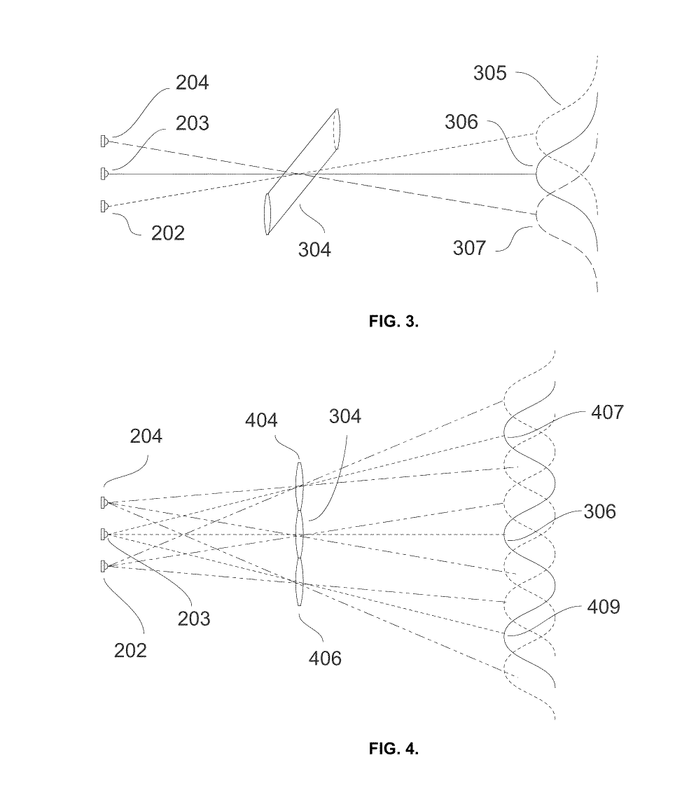

FIG. 3 further illustrates the operation principles of refractive pattern forming element. 304 is cylindrical lens. Conventional optical lens has radially symmetric, usually spherical surfaces. A point light source placed in the focal plane of conventional spherical lens forms a directed beam of light. Cylindrical lens has cylindrical surface which has focusing curvature only along one of the Cartesian coordinates, while it is essentially flat along the second direction. A point light source placed in the focal plane of cylindrical lens forms a ‘plane of light’, which is focused (has low angular divergence) along one direction and widely spread (has essentially higher angular divergence) along another direction. The intensity profile within this ‘plane of light’ depends on intensity profile of the light source, the profile of the cylindrical lens and the mutual location of the light source and the cylindrical lens.

305 is an intensity profile of the cross-section of the light from the light source 202; 303 is a profile corresponding to the light source 203, while 307 corresponds to the light source 204.

FIG. 4 further illustrates how the refractive element forms sine-like modulated light patterns. A refractive element disclosed in the present invention can be designed and built as several cylindrical lenses, adjacent to each other along their flat sides. Elements 404, 304, 406 illustrate the vertical cross-section of three adjacent cylindrical lenses. The light from the source 203 after passing through the lens 406 forms a image plane, which intensity cross-section is shown forms a spike 409; the light from the same source 203 after passing through the lens 304 forms a spike 306, while after passing through the lens 404 it forms the spike 407. Together the light planes, which intensity cross-section is shown as 409, 306 and 407 form the sine-like modulated pattern projected onto the scene. The light sources 202 and 204 form two other sine-like modulated patterns, shown dotted on the FIG. 4.

The light sources can emit the same or different emission spectrums in the visible and/or ultra-violet and/or infra-red bands. Using the light sources emitting in the infra-red (IR) band coupled with using the IR-sensitive camera allows to operate the 3D scanner in the invisible mode, without interfering with user perception. Using the light sources of different colors, e.g. Red, Green and Blue light sources allows color-separation of different patterns, with their simultaneous operation and acquisition in one frame instead of 3 consecutive frames. Using three light sources of the same spectrum allows more robustness in 3D scanning of color objects, and also allows switching them on simultaneously to obtain the uniform illumination, which can be used as a camera flash or illuminating lamp.

Illustrations on FIG. 3 and FIG. 4. Serve as non-limiting explanation. A specific shape and curvatures of the lenses, as well as the positions of the light sources may vary as should be obvious to anybody skilled in the art.

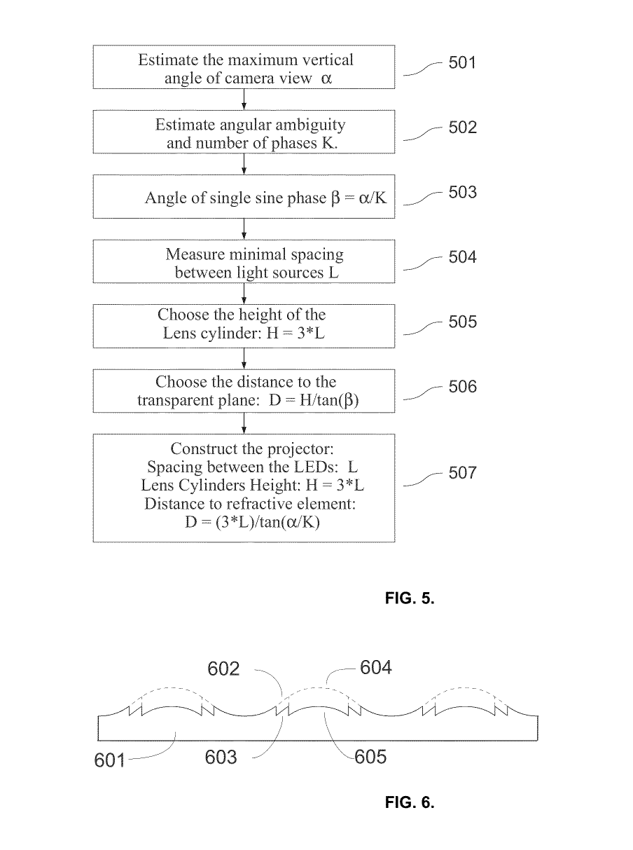

FIG. 5 illustrates one embodiment of a method for calculation of the shape of refractive element and geometry of pattern projector. In 501 the maximum angle of view of the camera in the direction of the pattern projector is evaluated. In 502 the number of sine periods K is chosen from considerations of the scene geometry and requirements of depth accuracy. In 505 the height of the lens cylinder is chosen to match the between the light sources. This is done to ensure the 2 Pi/3 mutual phase shifting of the patterns, for the case of 3 patterns, which is the preferred embodiment. 506 chooses the distance D to the transparent plane so that K cylindrical lenses together will cover the angle of camera view. The focal length of the lenses is adapted for proper brightness profile; approximately f≈D. 507 summarizes all the above calculations. This is a non-limiting procedure, and it can be varied in accordance to specific engineering requirements, number and shape of the light sources, number and type of patterns, etc., as should be obvious to anybody skilled in the art.

FIG. 6 illustrates two alternative embodiments of refractive pattern forming element, one is using the principles of Fresnel lens, another using the phase-shifting diffraction pattern. In the Fresnel lens implementation parts of the optical surface are shifted along the direction of the ray propagation to reduce the thickness and volume. Dashed line shows the conventional profile of refractive element, regions 603 and 605 of the Fresnel element correspond to regions 602 and 604 of the original element.

If the monochromatic light sources are used, e.g. laser diodes, the refractive phase-shifting diffraction pattern can be used, which is built on the similar principles, but with much finer surface steps, which are multiples of the light wavelength in the refractive media.

FIG. 7 illustrates another embodiment of pattern projector, utilizing the array of light sources 702 grown on the same substrate 701 and an optical lens 703 forming the pattern. In one embodiment the array of light sources is an array of vertical light emitting diodes (vertical LEDs) or vertical cavity surface emitting lasers (VCSEL).

Majority of light emitting diodes and laser diodes are manufactured in direct bandgap semiconductors, which consist from at least one element from the group of {B Al, Ga, In, Tl} and at least one element from the group {N,P,As,Sb,Bi}. Therefore, generic composition of 3-5 semiconductor can be described as

Bₓ₁Alₓ₂Gaₓ₃Inₓ₄Tlₓ₅N_{y1}P_{y2}As_{y3}Sb_{y4}Bi_{y5},

Where {B, Al, Ga, In, Tl}, {N,P,As,Sb,Bi} are respective chemical elements, and xiε[0,1]; yiε[0,1]; x1+x2+x3+x4+x5=y1+y2+y3+y4+y5=1, are their molar concentrations in the active region. The individual set of concentration values {x1, x2, x3, x4, x5}, {y1, y2, y3, y4, y5} of each group of LEDs defines the bandgap, which in turn defines the wavelength of light emitted by this group:

$$hv = h \frac{c}{λ} = {E}_{Gap} ( xi , yi ) ⇒ λ = \frac{hc}{{E}_{Gap} ( xi , yi )}$$

Therefore, we suggest growing the group of LEDs of different compositions to emit different wavelengths of light. This will allow the following advantages in functionality of the pattern projector: Color separation of the projected patterns, where the 3 consecutive patterns, which are projected sequentially during 3 consecutive frames on the monochromatic projector, are projected simultaneously, with first pattern being projected in the Red, second in the Green and third in the Blue band and acquired at the single color frame; using of visible band for conventional scene illumination and infra-red band for pattern projection; using the said pattern projector as color video projector for various related applications.

FIG. 8 shows a schematic block diagram of present invention. Pattern Projector 111 and the Camera 101 are synchronized together by Controller 801. The acquired image from the image sensor 102 is digitized in Analog-to-Digital converter (A/D) 802, than the raw image is transmitted to Image Signal Processor (ISP) 803. The Shutter, Aperture and gain of the camera may be controlled by Controller 801 based on the statistics obtained from ISP.

ISP 803 processes the image to adjust gain and white balance, enhance edges, remove noise, correct bad pixels, apply gamma correction and other possible processing operations, and stores the processed image in Random Access Memory (RAM) 804. The image frames are acquired sequentially by the camera, and each frame is illuminated by corresponding pattern, with patterns interchanging sequentially and cyclically. In the preferred embodiment there are 3 different patterns, and therefore any 3 consecutive image frames are acquired under 3 different projected patterns and sufficient for 3D reconstruction. Any new acquired frame substitutes the oldest frame in the RAM, so at any given moment 3 most recent image frames are available in the RAM.

In other embodiments of present invention, any other appropriate number of frames can be stored in RAM.

3D ISP 805 takes 3 most recent image frames from the RAM, calculates the 3D via the processing of these frames, and stores the 3D scan frame in the RAM. The algorithm for calculation of the 3D scan will be described below. Finally 3D video interface 806 further redirects the 3D scan frames for displaying on the screen, storage, transmittance or further processing. 2D video interface 807 may perform similar operations with conventional video output. 810 outlines the electronic circuitry of the 3D scanner.

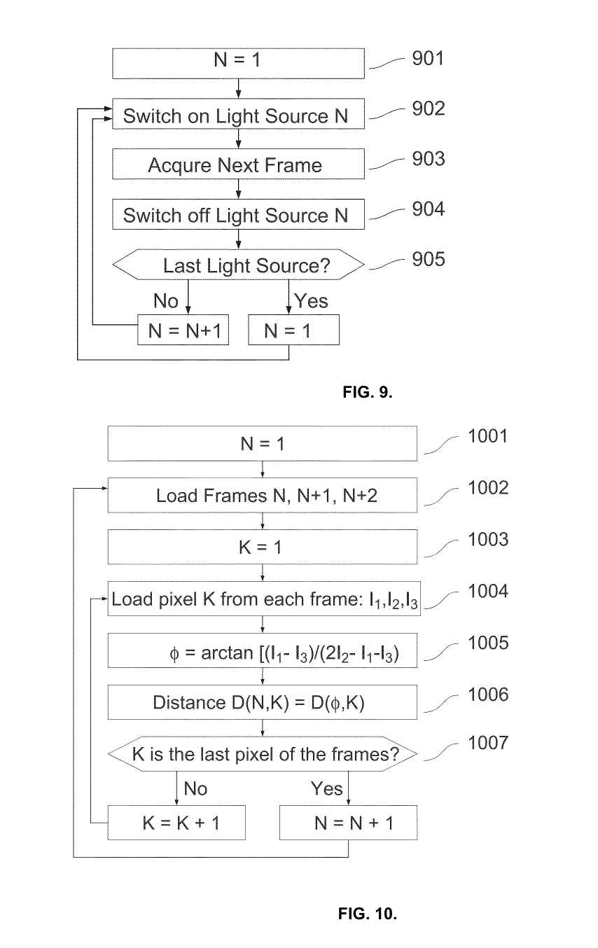

FIG. 9 illustrates one embodiment of a method to synchronize video frames acquisition in a camera and light pattern switching in the pattern projector. Initially the first light source N=1 is chosen in 901 and switched on in 902. A video frame is acquired by camera in 903. After the frame acquisition is finished, the light source N is switched off in 904, and pattern index N is incremented cyclically in 905, and the next pattern is acquired again under the illumination by the new pattern in 903.

FIG. 10 illustrates one embodiment of a method to calculate 3D scans in the preferred embodiment. For any three consecutive frames N, N+1, N+1, and for any pixel from these frames the phase of the sine pattern is evaluated in 1005:

φ=arctan └\sqrt{3}(I₁−I₃)/(2I₂−I₁−I₃)┘

This equation can be verified (by anybody skilled in the art of basic trigonometry) as a trigonometric equality, derived from the fact that

$${I}_{1} ( r , c ) = P ( r , c ) ( A sin ( ϕ ) + B )$$

$${I}_{2} ( r , c ) = P ( r , c ) ( Asin ( ϕ + \frac{2 π}{3} ) + B )$$

$${I}_{2} ( r , c ) = P ( r , c ) ( Asin ( ϕ + \frac{4 π}{3} ) + B ) ,$$

Where I₁(r,c),I₂(r,c),I₃(r,c) are the values of the pixel at row r and column c on three consecutive frame. These values are multiplication of the object albedo P(r,c), and its illumination by sine-modulated patterns

$$Asin ( ϕ + \frac{0 / 2 / 4 π}{3} )$$

and auxiliary illumination B. Note, that the equation in 1005 is invariant to both object albedo P(r,c) and auxiliary illumination B.

The distance is evaluated by triangulation, from the known phase φ, the mutual geometry of the projector and the camera, and from knowing the pixel row r and column c.

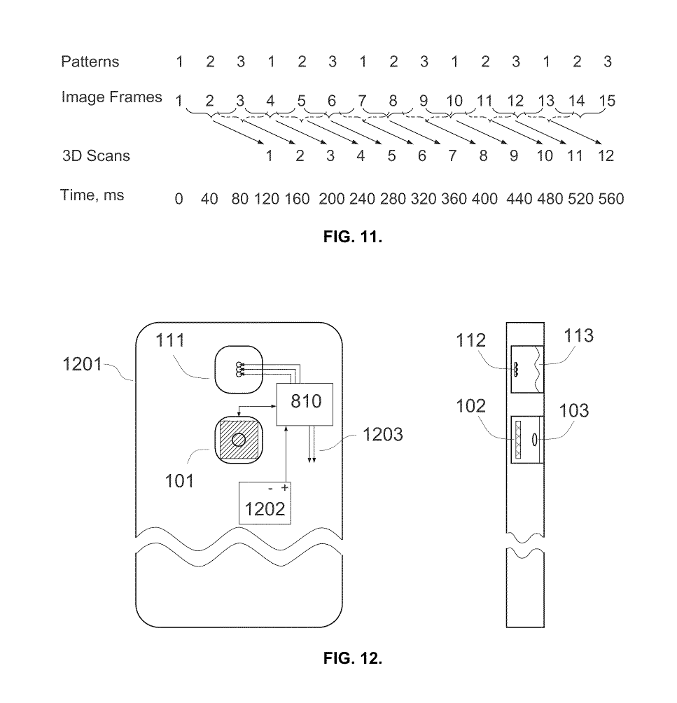

FIG. 11 illustrates the time sequence of illuminating patterns, acquired frames, and calculated 3D scans. One can note that the 3D scans have a certain delay over the image frames, since only after acquisition of three image frames the first 3D scan can be obtained. A non-limiting example of time-line is shown in the last row, corresponding to video frame-rate of 25 frames per second, or 40 milliseconds for each frame. The frame rate of calculated 3D scans is the same as the frame-rate of acquired images, however since each 3D scan is based on 3 image frames, they are more sensitive to motion of the objects, and have a certain delay of one or two frames. For example 3D scan 1 is calculated at t=120 ms from image frames 1, 2, 3 and correspond to the scene position during the Frames 1-3, acquired over an interval time interval 0-120 ms.

FIG. 12 illustrates one possible application of present invention, when it is incorporated in the mobile phone or other hand-held device. 101 is the imaging camera, 111 is the pattern projector, 810 is the electronic circuitry of the 3D scanner, 1202 is the battery of the mobile device, and 1203 are the data lines of the interface of the 3D scanner, which transmit 2D and 3D video frames for further processing, displaying, storage or transmittance.

1. A 3D scanning apparatus comprising
an imaging camera
a fixed pattern projector, comprising two or more independently switchable light sources and one or more transparent pattern forming element.
a controlling circuitry configured to switch between the light sources sequentially in synchronization with sequential acquisition of image frames.
a processing circuitry, configured to calculate a 3D scan of the scene from one or more images acquired under illumination of appropriate patterns.

2. An apparatus as in claim 1, where transparent pattern forming element has a spatially varying thickness and/or refraction coefficient.

3. An apparatus as in claim 2, where pattern forming element is designed with periodically modulated thickness to form sine-like projected patterns.

4. An apparatus as in claim 3, with 3 light sources, positioned with mutual phase shift of about 2 Pi/3.

5. An apparatus as in claim 2, where the said pattern forming element is profiled to form patterns so, that their superposition during simultaneous switching of two or more light sources results in essentially uniform illumination profile.

6. An apparatus as in claim 5, where the uniform illumination pattern is used as stills camera flash, or video camera auxiliary illumination lamp.

7. An apparatus as in claim 1, where the switchable light sources of the pattern projector are monochromatic light sources, and a transparent pattern forming element, is a phase-shifting diffraction pattern, forming a pre-defined spatial intensity profile.

8. An apparatus as in claim 7, where a pre-defined spatial intensity profile is a sine-modulated intensity profile.

9. An apparatus as in claim 2, where each light source has its own independent pattern forming element, forming an independent projecting unit capable to project single pre-defined light pattern.

10. An apparatus comprising two or more projecting units as in claim 9 assembled with proper relative distances and angles.

11. An apparatus as in claim 1, where the pattern projector consists of several independent pattern projecting units, each comprising a light source and individual refractive pattern forming element. The refractive element can be a transparent plate of varying thickness or Fresnel lens or phase-difference diffraction pattern.

12. An apparatus as in claim 10, where there are three projecting units, each forming a sine-like projection pattern, the said projecting units are assembled in a way providing the mutual 2 Pi/3 phase difference between the projected patterns.

13. An apparatus comprising:
An array of surface emitting laser diodes or light emitting diodes (LEDs) grown on the same substrate.
A control circuitry, wired to obtain an external control signal and power supply, and configured to set individual power level of the said LEDs in accordance to obtained control signal.

14. An apparatus as in claim 13, where the chemical composition of active regions of different LEDs is different, so that the wavelengths of emitted light are different.

15. An apparatus as in claim 14, where
The individual groups of LEDs of particular chemical composition are grown by Chemical Vapor Deposition (CVD) on the open regions, while masking the regions corresponding to LEDs of other groups with other chemical composition.
The active regions of the LEDs being composed of 3-5 direct bandgap semiconductor, having the composition:
Bₓ₁Alₓ₂Gaₓ₃Inₓ₄Tlₓ₅N_{y1}P_{y2}As_{y3}Sb_{y4}Bi_{y5},
Where B, Al, Ga, In, Tl, N, P, As, Sb, Bi are respective chemical elements, and ε[0,1]; yiε[0,1]; x1+x2+x3+x4+x5=y1+y2+y3+y4+y5=1, are their molar concentrations in the active region. The individual set of concentration values {x1, x2, x3, x4, x5}, {y1, y2, y3, y4, y5} of each group of LEDs defines the wavelength of light emitted by this group.

16. An apparatus as in claim 14, comprising LEDs of 3 groups of chemical composition, emitting in the Red (600 nm-700 nm), Green (500-600 nm) and Blue (400-500 nm) bands.

17. An apparatus as in claim 13, further comprising optical lens positioned to project a pattern formed by the said array of LEDs.

18. An apparatus as in claim 16, further comprising an imaging camera, and configured to project a sequence of auxiliary illumination patterns synchronously with image acquisition in the said camera. The said patterns being designed to allow 3D reconstruction from the acquired images.

19. An apparatus as in claim 13, further comprising an interface circuitry, capable to obtain an encoded video signal, decode it and apply to control the brightness of the LEDs in the array so that they display the obtained video.

20. An apparatus as in claim 19, further comprising an optical lens to project the video, displayed on the LED array.
